(19) United States
(12) Patent Application Publication
(10) Pub. No.: US 2016/0321025 A1
(43) Pub. Date: Nov. 3, 2016

(54) ELECTRONIC APPARATUS AND METHOD

(71) Applicant: KABUSHIKI KAISHA TOSHIBA, Tokyo (JP)

(72) Inventors: Shogo Ikeda, Kunitachi Tokyo (JP); Tatsuo Yamaguchi, Kunitachi Tokyo (JP); Toshiyuki Yamagami, Fussa Tokyo (JP); Yukihiro Kurita, Kokubunji Tokyo (JP); Yuki Kanbe, Ome Tokyo (JP)

(21) Appl. No.: 15/009,147

(22) Filed: Jan. 28, 2016

Related U.S. Application Data
(60) Provisional application No. 62/154,895, filed on Apr. 30, 2015.

(51) Int. Cl. G06F 3/14; G06F 3/0482; G06F 3/0484; G06F 3/0481; G06F 3/0488

(52) U.S. Cl. CPC G06F 3/1454; G06F 3/04817; G06F 3/04883; G06F 3/04842; G06F 3/0482

(57) ABSTRACT

According to one embodiment, an electronic apparatus includes a hardware processor configured to display a first icon indicative of a first group and a second icon indicative of a second group, display handwriting made on a first electronic apparatus and a second electronic apparatus of the first group if the first icon is selected, display handwriting made on a third electronic apparatus and a fourth electronic apparatus of the second group if the second icon is selected, receive a selection of a first file, transmit the first file to the first and second electronic apparatus if the first group is selected through the first icon, and transmit the first file to the third and fourth electronic apparatus if the second group is selected through the second icon.

### CROSS-REFERENCE TO RELATED APPLICATIONS

This application claims the benefit of U.S. Provisional Application No. 62/154,895, filed Apr. 30, 2015, the entire contents of which are incorporated herein by reference.

### FIELD

Embodiments described herein relate generally to an electronic apparatus and a method.

### BACKGROUND

In recent years, various electronic apparatuses such as tablet computers, personal digital assistants (PDAs) and smartphones have become widespread. Most of these types of electronic apparatus include a touchscreen display for facilitating an input operation by a user.

Furthermore, recently, a technique of sharing information among a group constituted of users using electronic apparatuses has been developed.

By this technique, the same information can be displayed on touchscreen displays of the electronic apparatuses used by the respective users constituting the group (users participating in the group).

However, it has not been considered yet that a user other than the users constituting the group (that is, a user not participating in the group) distributes information to be shared among the group to (the users constituting) the group.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outside of an electronic apparatus according to an embodiment.

FIG. 2 is a diagram showing an example of connection between apparatuses using a handwriting collaboration function.

FIG. 3 is a diagram showing an example of a flow of data between an owner apparatus and participant apparatuses.

FIG. 4 is a diagram for explaining an example of shared screen images.

FIG. 5 is an exemplary diagram showing a relationship between respective strokes on the shared screen images and writers.

FIG. 6 is a diagram for explaining an example of stroke data.

FIG. 7 is an exemplary diagram for explaining an outline of handwritten document data including stroke data.

FIG. 8 is a diagram showing an example of a system configuration of the electronic apparatus.

FIG. 9 is a diagram showing an example of a functional configuration of the electronic apparatus.

FIG. 10 is a diagram showing an example of a data structure of a database.

FIG. 11 is a diagram showing an example of the data structure in the case of management for each point data item.

FIG. 12 is a sequence chart showing an example of a procedure of a distribution process of shared information.

FIG. 13 is a diagram showing an example of a top screen image in the handwriting collaboration function.

FIG. 14 is a diagram for explaining an example of a distribution operation.

FIG. 15 is a diagram for explaining an example of transition of shared screen images displayed in intragroup apparatuses.

FIG. 16 is a diagram for explaining the example of transition of the shared screen images displayed in the intragroup apparatuses.

FIG. 17 is a sequence chart showing an example of a procedure of a collection process of shared information.

FIG. 18 is a diagram for explaining an example of how the electronic apparatus is used.

FIG. 19 is a diagram for explaining an example of how the electronic apparatus is used.

FIG. 20 is a diagram for explaining an example of how the electronic apparatus is used.

FIG. 21 is a diagram for explaining an example of how the electronic apparatus is used.

### DETAILED DESCRIPTION

Various embodiments will be described hereinafter with reference to the accompanying drawings.

In general, according to one embodiment, an electronic apparatus includes a transceiver configured to receive handwriting made on other electronic apparatuses, a screen capable of displaying the handwriting, and a hardware processor. The hard ware processor is configured to display a first icon indicative of a first group comprising a first electronic apparatus and a second electronic apparatus and a second icon indicative of a second group comprising a third electronic apparatus and a fourth electronic apparatus, display handwriting made on the first electronic apparatus and the second electronic apparatus, if the first icon is selected by a user, display handwriting made on the third electronic apparatus and the fourth electronic apparatus, if the second icon is selected by the user, receive a selection of a first file, transmit the first file to the first electronic apparatus and the second electronic apparatus, if the first group is selected as a destination of the first file through the first icon, and transmit the first file to the third electronic apparatus and the fourth electronic apparatus, if the second group is selected as the destination of the first file through the second icon.

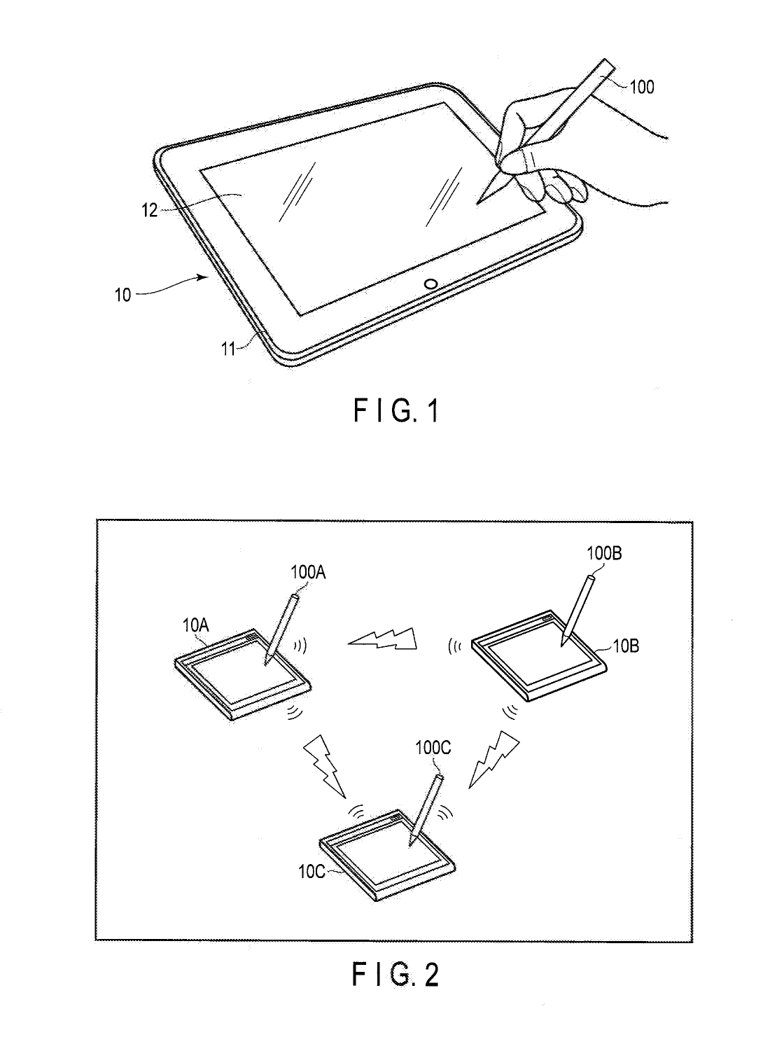

FIG. 1 is a perspective view showing an outside of an electronic apparatus according to one embodiment. The electronic apparatus is, for example, a pen-based portable electronic apparatus in which handwriting input can be performed with a pen (stylus) or a finger. The electronic apparatus can be implemented as a tablet computer, a notebook personal computer, a smartphone, a PDA, etc. FIG. 1 shows an example in which the electronic apparatus is implemented as a tablet terminal. In the following description, it is assumed that the electronic apparatus according to the present embodiment is implemented as a tablet computer. The tablet computer is a portable electronic apparatus which is also called a tablet or a slate computer.

An electronic apparatus 10 shown in FIG. 1 includes a main body 11 and a touchscreen display 12. The main body 11 includes a housing in the shape of a thin box, and the touchscreen display 12 is mounted to be laid on a top surface of the main body 11.

In the touchscreen display 12, a flat panel display and a sensor are incorporated. The sensor is configured to detect a touch position of the pen or the finger on a screen of the flat panel display. The flat panel display may be, for example, a liquid crystal display (LCD). As the sensor, for example, a capacitive touchpanel or an electromagnetic induction type digitizer can be used. In the following description, it is assumed that both the two kinds of sensor, the digitizer and the touchpanel, are incorporated in the touchscreen display 12.

The touchscreen display 12 can detect not only a touch operation on the screen with the finger but a touch operation on the screen with a pen 100. The pen 100 may be, for example, an electromagnetic induction type pen (digitizer pen). A user can perform a handwriting input operation on the touchscreen display 12 with an external object (finger or pen 100). Through the handwriting input operation, the user can write characters, etc., on the screen of the touchscreen display 12. During the handwriting input operation, a path of movement of the pen 100 on the screen, that is, a path (handwriting) of a stroke handwritten by the handwriting input operation, is drawn in real time, whereby a path of each stroke is displayed on the screen. A path of movement of the pen 100 made while the pen 100 touches the screen corresponds to one stroke. A set of many strokes corresponding to handwritten characters, figures, or the like, that is, a set of many paths (handwriting) constitute a handwritten document.

Although the external object may be either the finger or the pen 100, the case where handwriting input is performed with the pen 100 will be mainly described hereinafter.

In the present embodiment, a handwritten document is saved on a storage medium, not as image data, but as data indicating a coordinate string of a path of each stroke and the order of strokes (hereinafter, referred to as handwritten document data). The handwritten document data, details of which will be described later, indicates the order in which strokes were handwritten (that is, writing order), and includes stroke data items corresponding to the strokes, respectively. In other words, the handwritten document data means a set of time-series stroke data items corresponding to the strokes, respectively. Each stroke data item corresponds to one stroke, and includes (a set of) point data items corresponding to respective points on a path of the stroke. Each point data indicates coordinates of a corresponding point.

Moreover, the electronic apparatus 10 has a handwriting collaboration function. The handwriting collaboration function provides, for example, a service which enables shared information including stroke data to be shared between apparatuses including the electronic apparatus 10. By the handwriting collaboration function, users using the respective apparatuses can view shared information that has been shared, exchange the shared information between the apparatuses, and edit the shared information by collaborative work with each other. The shared information which is sharable by the handwriting collaboration function includes, for example, handwritten document data, text data, presentation data, word processing data, image data, spread sheet data, and a combination thereof.

The handwriting collaboration function is used by a group including users (group in which users participate). The group includes an owner of the group and one or more participants in the group. In one group, the owner is one person and the participants are one or more persons.

By the handwriting collaboration function, information (stroke data, text, etc.) input in an apparatus used by a user participating in (logging in to) a group is distributed in real time to apparatuses used by the other users participating the group. The content of shared information (editing content) displayed on display screens of the respective apparatuses used by the users participating in the group can be thereby synchronized. Strokes and texts input by different users may be displayed in different forms (for example, in different colors, with different types of pen, etc.) so that the users who input them are distinguishable.

FIG. 2 shows an example of connection between apparatuses (electronic apparatuses) using the handwriting collaboration function.

An apparatus 10A is, for example, an electronic apparatus 10 used by a user A. An apparatus 10B is, for example, an electronic apparatus 10 used by a user B. An apparatus 10C is an electronic apparatus 10 used by a user C. That is, each of the apparatuses 10A to 10C has the same handwriting collaboration function as that of the electronic apparatus 10 according to the present embodiment.

The users A to C using the handwriting collaboration function constitute one group. In this case, the apparatuses 10A to 10C are wirelessly connected to each other. In the wireless connection, an arbitrary wireless connection standard according to which apparatuses can be wirelessly connected to each other is used. Specifically, Wi-Fi (registered trademark), Wi-Fi Direct (registered trademark), and Bluetooth (registered trademark) may be used, for example.

Hereinafter, apparatuses (here, the apparatuses 10A to 10C) used by respective users (here, the users A to C) constituting one group using the handwriting collaboration function will be referred to as intragroup apparatuses.

Any one of the intragroup apparatuses operates as a server apparatus configured to manage (the group in) the handwriting collaboration function. In the following description, it is assumed that an apparatus used by an owner of the group operates as a server apparatus. Hereinafter, an intragroup apparatus which is used by the owner and operates as the server apparatus will be referred to as an owner apparatus, and intragroup apparatuses other than the owner apparatus will be referred to as participant apparatuses.

(A user using) the owner apparatus may have, for example, authority over whether to permit (a user using) an apparatus to participate in a group. In this case, only an apparatus which has received permission to participate in (log in to) the group from the owner apparatus can participate in the group.

When each of the apparatuses participates in a group, IDs (accounts) of the apparatuses may be used, or IDs (accounts) of the users using the apparatuses may be used.

Here, the case where the users A to C constitute the same group will be assumed. In this case, in each of the apparatuses 10A to 10C, a shared screen image (page) on which shared information can be viewed is displayed. The shared screen image is used as a display area (editing area) common to the apparatuses 10A to 10C. The shared screen image enables visual communication between the apparatuses 10A to 10C. The visual communication enables information such as a text, an image, a handwritten character, a handwritten figure, and a diagram to be shared and exchanged in real time between the apparatuses.

Information (stroke data, a text, etc.) which each of the users A to C input on the screen of his or her own apparatus is not only displayed on the shared screen image of his or her own apparatus, but also reflected in real time in the shared screen images of the apparatuses used by the other users. As a result, information input by each of the users A to C can be exchanged and shared between the users A to C.

The apparatuses 10A to 10C can also display, for example, content such as teaching materials used in an educational scene such as a school on the shared screen images as shared information. In this case, in each of the apparatuses 10A to 10C, stroke data (handwritten data) can be input in handwriting on the shared screen images where the content is displayed. The users A to C can thereby exchange and share a handwritten character, a handwritten figure, etc., handwritten on the content between the users A to C.

The size of the shared screen images can be arbitrarily set, and can also be set to exceed the size (resolution) of a physical screen of each of the apparatuses.

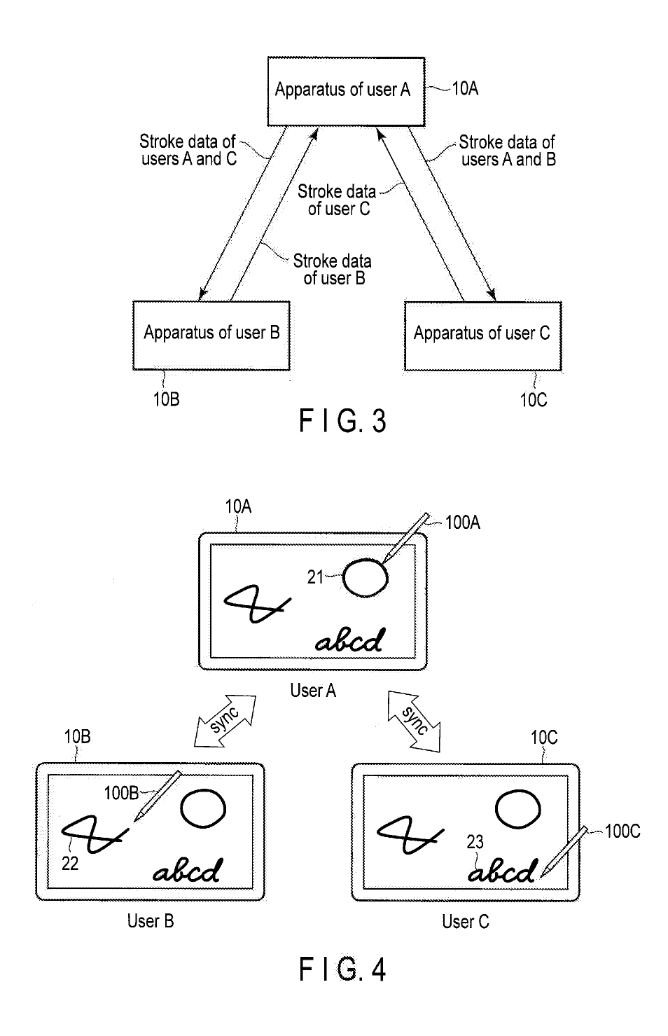

FIG. 3 shows a flow of data between an owner apparatus (server apparatus) and participant apparatuses.

In FIG. 3, the case where the apparatus 10A used by the user A operates as the server apparatus is assumed. That is, the user A using the apparatus 10A is an owner of a group, and the users B and C using the apparatuses 10B and 10C are participants in the group.

The flow of data between the apparatus (owner apparatus) 10A and the apparatuses (participant apparatuses) 10B and 10C will be described by taking the case where stroke data (handwritten data) is exchanged and shared between the apparatuses, although the present embodiment is not limited to this case.

The apparatus 10A, which is the owner apparatus, receives stroke data input in handwriting in the apparatus 10B, which is a participant apparatus, from the apparatus 10B. In addition, the apparatus 10A receives stroke data input in handwriting in the apparatus 10C, which is the other participant apparatus, from the apparatus 10C.

Moreover, the apparatus 10A transmits stroke data input in handwriting in the apparatus 10A and stroke data received from the apparatus 10C to the apparatus 10B. In addition, the apparatus 10A transmits stroke data input in handwriting in the apparatus 10A and stroke data received from the apparatus 10B to the apparatus 10C.

Thus, on a display (shared screen image) of the apparatus 10A, not only stroke data of the user A, but also stroke data of the user B, and further stroke data of the user C, are displayed.

Similarly, on a display (shared screen image) of the apparatus 10B, not only stroke data of the user B, but also stroke data of the user A, and further stoke data of the user C, are displayed.

Furthermore, on a display (shared screen image) of the apparatus 10C, not only stroke data of the user C, but also stroke data of the user A, and further stroke data of the user B, are displayed.

The apparatus 10A stores stroke data input in handwriting in each of the apparatuses in a database (not shown) provided in the apparatus 10A. This database is used to manage shared information including handwritten document data (stroke data), etc., generated and edited by collaborative work.

FIG. 4 is a diagram for explaining the shared screen images displayed in the apparatuses 10A to 10C. When the handwriting collaboration function is used, the apparatus 10A, which is the owner apparatus, and the apparatuses 10B and 10C, which are the participant apparatuses, are wirelessly connected to each other. By the handwriting collaboration function, screen display and handwriting operation are synchronized between the apparatuses 10A and 10B and between the apparatus 10A and the apparatus 10C, whereby the users A to C can simultaneously perform handwriting on the same shared screen images displayed in the apparatuses 10A to 10C.

In the example shown in FIG. 4, the strokes 21 to 23 are displayed in the same way on the respective shared screen images of the apparatuses 10A to 10C. As shown in FIG. 5, the stroke 21 is a stroke (data) input in handwriting by the user A in the apparatus 10A. The stroke 22 is a stroke (data) input in handwriting by the user B in the apparatus 10B. The stroke 23 is a stroke (data) input in handwriting by the user C in the apparatus 10C.

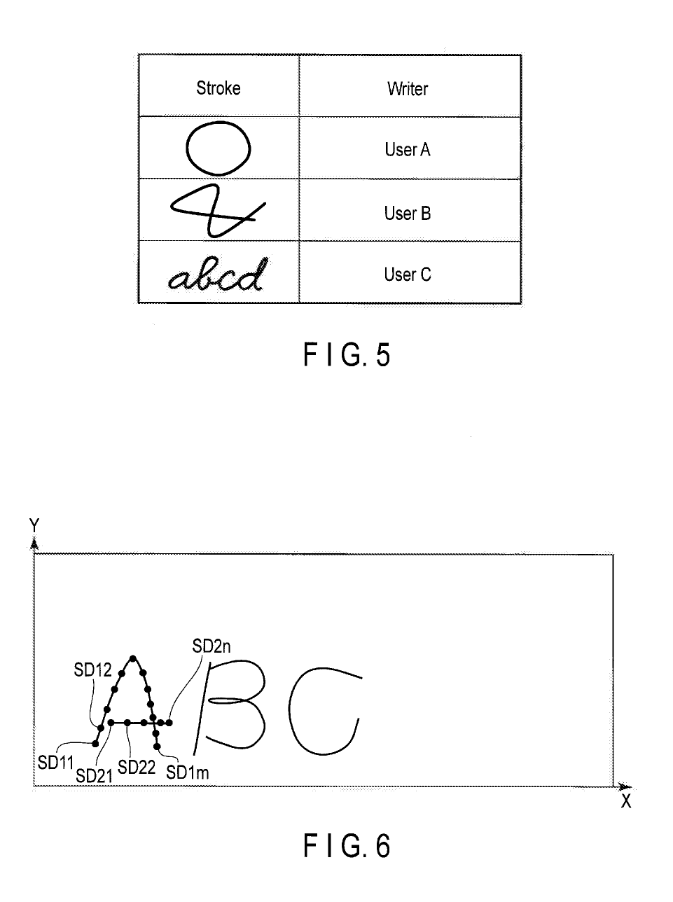

Next, stroke data will be explained with reference to FIG. 6.

In FIG. 6, the case where a handwritten character string “ABC” was handwritten in the order of “A”, “B” and “C” is assumed.

The handwritten character “A” is represented by, for example, two strokes (a path in the shape of “ [symbol] ” and a path in the shape of “-”) handwritten with the pen 100.

While the pen 100 is moving, the path in the shape of “ [symbol] ” of the pen 100 is sampled in real time. Point data items (coordinate data items) SD11, SD12, . . . , SD1m corresponding to respective points on the path in the shape of “ [symbol] ” of the pen 100 are thereby acquired successively. That is, if the stroke in the shape of “ [symbol] ” was handwritten with the pen 100, stroke data including the point data items SD11, SD12, . . . , SD1m is acquired. For example, whenever the position of the pen 100 on the screen moves by a predetermined amount, a point data item indicating a new position may be acquired. Although the density of point data items is drawn low for simplifying a diagram in FIG. 6, point data items are actually acquired in higher density. The point data items SD11, SD12, . . . , SD1m included in the stroke data are used to draw the path in the shape of “ [symbol] ” of the pen 100 on the screen. The path in the shape of “ [symbol] ” of the pen 100 is drawn in real time on the screen so as to follow the movement of the pen 100.

Similarly, the path in the shape of “-” of the pen 100 is also sampled in real time while the pen 100 is moving. Point data items (coordinate data items) SD21, SD22, . . . , SD2n corresponding to respective points on the path in the shape of “-” of the pen 100 are thereby acquired successively. That is, if the path in the shape of “-” of the pen 100 was handwritten with the pen 100, stroke data including the point data items SD21, SD22, . . . , SD2n is acquired.

The handwritten character “B” is represented by, for example, two strokes handwritten with the pen 100. The handwritten character “C” is represented by, for example, one stroke handwritten with the pen 100.

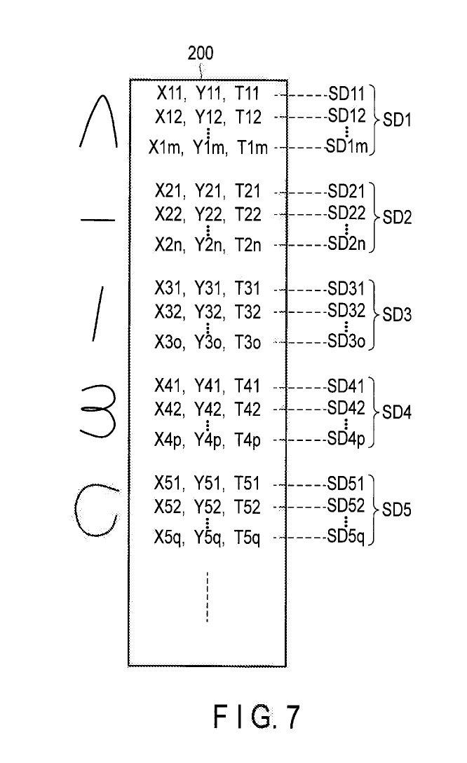

An outline of handwritten document data 200 including the stroke data explained with reference to FIG. 6 will be described with reference to FIG. 7.

The handwritten document data 200 includes stroke data items SD1, SD2, . . . , SD5. In the handwritten document data 200, these stroke data items SD1, SD2, . . . , SD5 are chronologically arranged in writing order, that is, the order in which strokes were handwritten.

In the handwritten document data 200, the first and second stroke data items SD1 and SD2 represent the two strokes of the handwritten character “A”, respectively. The third and fourth stroke data items SD3 and SD4 represent the two strokes constituting the handwritten character “B”, respectively. The fifth stroke data item SD5 represents the one stroke constituting the handwritten character “C”.

Each stroke data item includes point data items (coordinate data) corresponding to one stroke. In each stroke data item, point data items are chronologically arranged in the order in which strokes were written. For example, regarding the handwritten character “A”, the stroke data item SD1 includes point data items corresponding to respective points on the path of the stroke in the shape of “ [symbol] ” of the handwritten character “A”, that is, the m coordinate data items SD11, SD12, . . . , SD1m. The number of point data items may vary from stroke data item to stroke data item, or may be the same.

Each point data item indicates x- and y-coordinates corresponding to a certain point on a corresponding path. For example, the point data item SD11 indicates an x-coordinate (X11) and a y-coordinate (Y11) of a start point of the stroke in the shape of “ [symbol] ”. The point data item SD1m indicates an x-coordinate (X1m) and a y-coordinate (Y1m) of an end point of the stroke in the shape of “ [symbol] ”.

Each point data item may include timestamp data T corresponding to a point in time (sampling timing) when a point corresponding to coordinates indicated by the point data item was handwritten. The point in time when the point was handwritten may be an absolute time (for example, year/month/day/hour/minute/second) or a relative time determined with respect to a certain point in time. For example, an absolute time when a stroke started being written may be added to each stroke data item as timestamp data, and a relative time indicating a difference from the absolute time may be further added to point data items in each stroke data item as timestamp data T.

By using time-series data including the timestamp data T added to each point data in this manner, a temporal relationship between strokes can be more accurately indicated. Although not shown in FIG. 7, data (Z) indicating writing pressure may be added to each point data item.

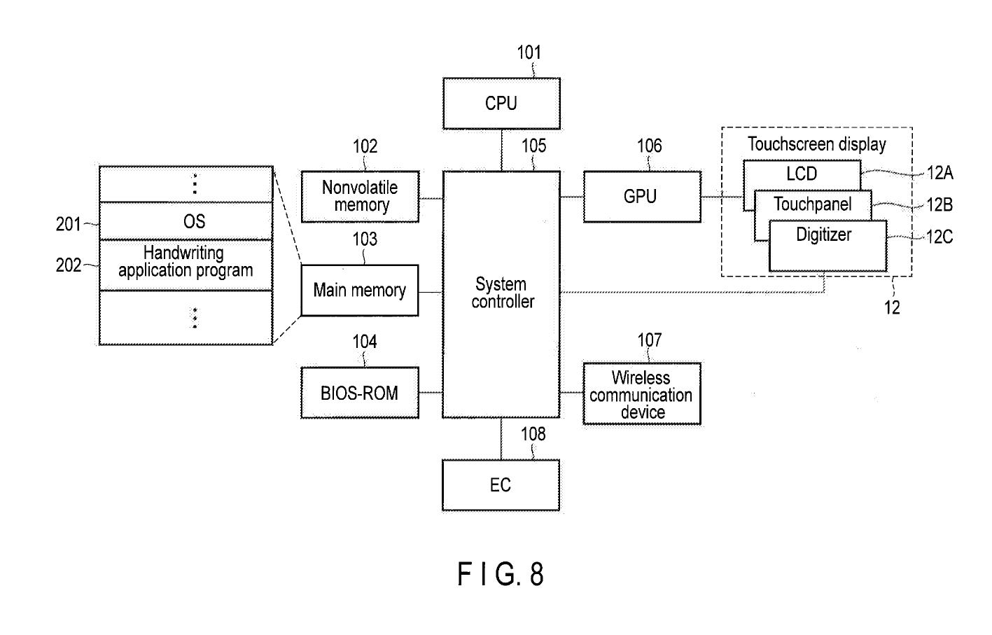

FIG. 8 shows a system configuration of the electronic apparatus 10.

As shown in FIG. 8, the electronic apparatus 10 includes a CPU 101, a nonvolatile memory 102, a main memory 103, a BIOS-ROM 104, a system controller 105, a graphics processing unit (GPU) 106, a wireless communication device (transceiver) 107, an embedded controller (EC) 108, etc. Further, in the electronic apparatus 10, the touchscreen display 12 shown in FIG. 1 includes an LCD 12A, a touchpanel 12B, and a digitizer 12C.

The CPU 101 is a processor which controls operation of various components in the electronic apparatus 10. The processor includes a processing circuit. The CPU 101 executes various programs loaded from the nonvolatile memory 102, which is a storage device, into the main memory 103. These programs include an operating system 201, and various application programs. The application programs include a handwriting application program 202.

The handwriting application program 202 has a function of generating and displaying handwritten document data, a function of editing handwritten document data, a handwritten document search function of searching for handwritten document data including a desired handwritten portion and a desired handwritten portion in handwritten document data, etc.

Moreover, the handwriting application program 202 has a handwriting collaboration function for sharing shared information including stroke data between apparatuses (that is, synchronizing the content of shared information between apparatuses).

In addition, the CPU 101 also executes a Basic Input/Output System (BIOS) stored in the BIOS-ROM 104. The BIOS is a program for hardware control.

The system controller 105 is a device which connects a local bus of the CPU 101 and various components. The system controller 105 also contains a memory controller which exerts access control over the main memory 103. In addition, the system controller 105 also has a function of communicating with the GPU 106 through a serial bus conforming to the PCI EXPRESS standard, etc.

The GPU 106 is a display processor which controls the LCD 12A used as a display monitor of the electronic apparatus 10. A display signal generated by the GPU 106 is transmitted to the LCD 12A. The LCD 12A displays a screen image on the basis of the display signal.

On an upper surface side of the LCD 12A, the touchpanel 12B is disposed. The touchpanel 12B is a capacitive pointing device for performing input on a screen of the LCD 12A. A touch position on the screen which the finger touches, the movement of the touch position, etc., are detected by the touchpanel 12B.

On a lower surface side of the LCD 12A, the digitizer 12C is disposed. The digitizer 12C is an electromagnetic induction type pointing device for performing input on the screen of the LCD 12A. A touch position on the screen which the pen 100 touches, the movement of the touch position, etc., are detected by the digitizer 12C.

The wireless communication device 107 is a device configured to communicate wirelessly by, for example, Wi-Fi, Wi-Fi Direct or Bluetooth described above.

The EC 108 is a single-chip microcomputer including an embedded controller for power management. The EC 108 has a function of powering on or off the electronic apparatus 10 in accordance with the user's operation of a power button.

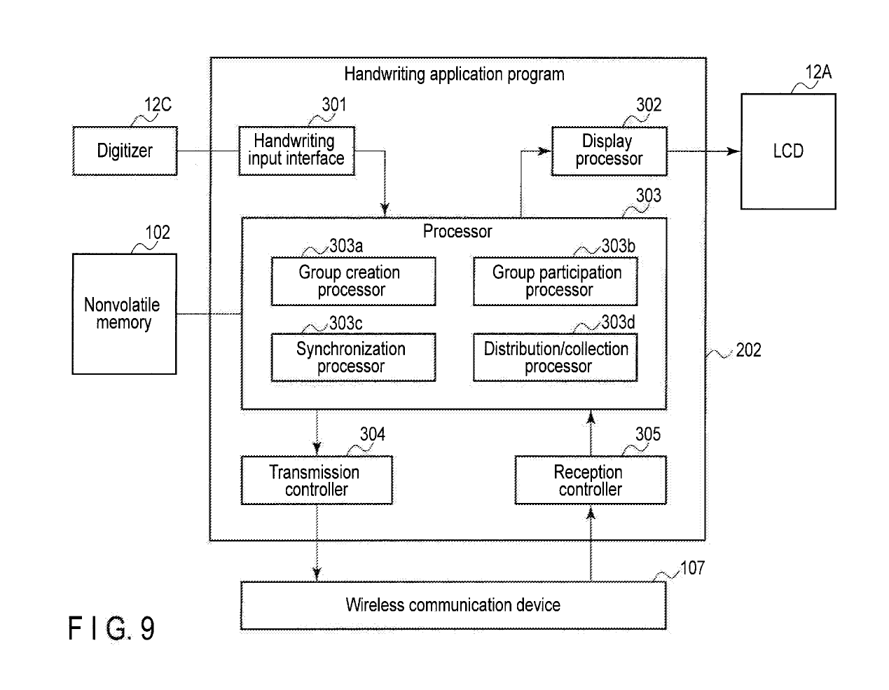

Next, a functional configuration of the electronic apparatus 10 implemented when the CPU 101 (computer of the electronic apparatus 10) executes the handwriting application program 202 will be described with reference to FIG. 9. Here, a functional configuration related to the above-described handwriting collaboration function will be mainly described.

The handwriting application program 202 includes a handwriting input interface 301, a display processor 302, a processor 303, a transmission controller 304, a reception controller 305, etc., as function execution modules for sharing shared information between apparatuses.

The digitizer 12C of the touchscreen display 12 is configured to detect the occurrence of events such as “touch”, “move (slide)” and “release”. The “touch” event is an event indicating that a pen has touched the screen. The “move (slide)” event is an event indicating that a touch position has been moved while the pen touches the screen. The “release” event is an event indicating that the pen has been released from the screen.

The handwriting input interface 301 is an interface configured to perform handwriting input in collaboration with the digitizer 12C of the touchscreen display 12. The handwriting input interface 301 receives the “touch” or “move (slide)” event from the digitizer 12C of the touchscreen display 12, thereby detecting a handwriting input operation. The “touch” event includes coordinates of a touch position. The “move (slide)” event also includes coordinates of the touch position which has been moved. Thus, the handwriting input interface 301 can receive a coordinate string (point data items) corresponding to a path of movement of the touch position from the touchscreen display 12.

The display processor 302 displays part or all of the above-described shared screen image (page) on the LCD 12A. In addition, the display processor 302 displays each stroke input in handwriting by a handwriting input operation with the pen 100 on the LCD 12A on the basis of a coordinate string from the handwriting input interface 301. Moreover, the display processor 302 displays information written in shared screen images of other electronic apparatuses on the LCD 12A under the control of the processor 303.

The processor 303 executes a process for sharing shared information including stroke data between apparatuses including the electronic apparatus 10. The processor 303 includes a group creation processor 303a, a group participation processor 303b, a synchronization processor 303c, and a distribution/collection processor 303d.

The group creation processor 303a is a functional module which executes a process for the electronic apparatus 10 to operate as the above-described owner apparatus (server apparatus). Specifically, the group creation processor 303a creates a group whose owner is a user using the electronic apparatus 10. In addition, the group creation processor 303a can determine whether to permit another user who makes a request to participate in the created group to participate in the group. The group creation processor 303a has a function of managing (participant apparatuses used by) respective participants in the above-described group.

The group participation processor 303b is a functional module which executes a process for the electronic apparatus 10 to operate as the above-described participant apparatus. Specifically, the group participation processor 303b makes a request to participate in a group already created (existing) by (an apparatus used by) another user. When it is permitted to participate in the group, the electronic apparatus 10, which is the participant apparatus, is connected to an owner apparatus.

An owner apparatus and participant apparatuses are connected by Wi-Fi, Wi-Fi Direct, Bluetooth, or the like.

The synchronization processor 303c executes a process for synchronizing the content of shared information between the electronic apparatus 10 and the apparatuses used by the other users constituting the same group with the user using the electronic apparatus 10 (owner apparatus and participant apparatuses). Shared information synchronized between the owner apparatus and the participant apparatuses are managed in the electronic apparatus 10, using, for example, a database implemented as the nonvolatile memory 102. Shared information managed in the electronic apparatus 10 includes, for example, stroke data input in handwriting on the shared screen image displayed in the electronic apparatus 10, and stroke data received from the respective apparatuses used by the other users constituting the same group as the user using the electronic apparatus 10. Shared information managed by the synchronization processor 303c may include text data, presentation data, word processing data, image data, spread sheet data, etc., as well as stroke data. Shared information may be managed, for example, only when the electronic apparatus 10 operates as the owner apparatus.

Here, the electronic apparatus 10 according to the present embodiment can execute a predetermined process for a group (owner apparatus and participant apparatuses) in the case where the user using the electronic apparatus 10 does not constitute the group (that is, does not participate in the group). Hereinafter, an apparatus used by a user not participating in a group will be referred to as an extragroup apparatus.

The distribution/collection processor 303d is a functional module which executes a process for the electronic apparatus 10 to operate as the above-described extragroup apparatus. The distribution/collection processor 303d executes, for example, a process of distributing (transferring) shared information to (apparatuses used by) users constituting a pre-existing group (hereinafter, referred to as a distribution process of shared information), and a process of collecting (acquiring) shared information from (the apparatuses used by) the users constituting the group (hereinafter, referred to as a collection process of shared information). Details of these processes will be described later.

The transmission controller 304 executes a process for transmitting stroke data, etc., input in handwriting on the shared screen image displayed in the electronic apparatus 10 to other apparatuses, using the wireless communication device 107 under the control of the processor 303.

The reception controller 305 executes a process for receiving stroke data, etc., input in handwriting on shared screen images displayed in other apparatuses from the other apparatuses, using the wireless communication device 107 under the control of the processor 303.

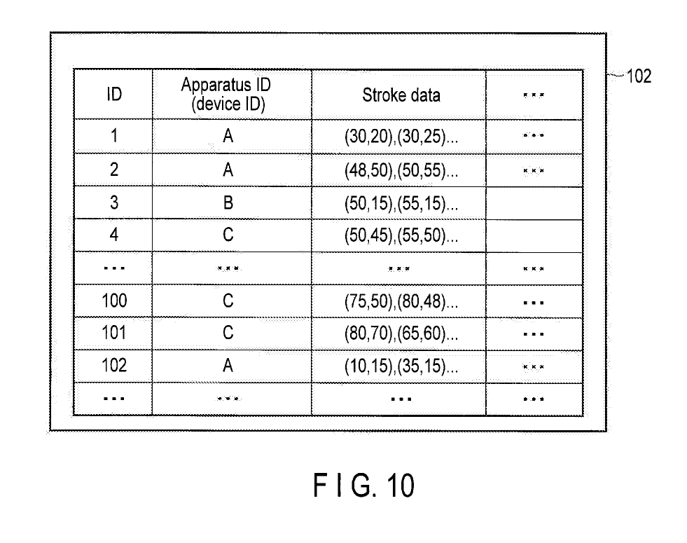

FIG. 10 shows an example of a data structure of the database implemented as the nonvolatile memory 102. FIG. 10 shows the example in which (handwritten document data including) stroke data input in handwriting on shared screen images displayed in respective intragroup apparatuses (owner apparatus and participant apparatuses) is stored in the database as shared information.

In the database shown in FIG. 10, a number of records (a number of storage areas) to which record IDs are allocated, respectively, are stored. One stroke data item (one stroke) is allocated to one record.

The record IDs (numbers) allocated to the respective records indicate the order in which stroke data items allocated to the respective records were input in handwriting. In each of the records, an apparatus ID (device ID), stroke data (coordinate string), etc., are stored.

Moreover, a user ID corresponding to stroke data (that is, an identifier for identifying a user who input the stroke data in handwriting), a time when the stroke data was handwritten (timestamp data), etc., may be stored in each of the records.

In the example shown in FIG. 10, stroke data input in handwriting in an apparatus identified by an apparatus ID “A” (for example, the apparatus 10A) is stored in each of the records having a record ID “1”, a record ID “2”, and a record ID “102”. In addition, stroke data input in handwriting in an apparatus identified by an apparatus ID “B” (for example, the apparatus 10B) is stored in a record having a record ID “3”. Moreover, stroke data input in handwriting in an apparatus identified by an apparatus ID “C” (for example, the apparatus 10C) is stored in each of the records having a record ID “4”, a record ID “100”, and a record ID “101”.

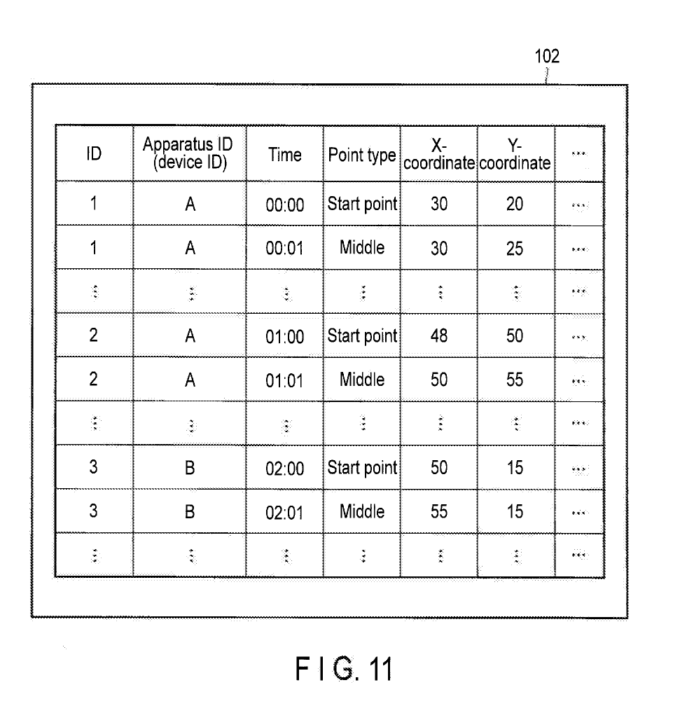

Although it has been explained that one stroke data item is allocated to one record (that is, shared information is managed for each stroke data item) in the example shown in FIG. 10, each stroke data item is a set of point data items (coordinate data items) as described above. Thus, for example, one point data item may be allocated to one record as shown in FIG. 11 (that is, shared information is managed for each point data item). If shared information is managed for each point data item in this manner, the transmission and reception of stroke data, which is performed when the above-described handwriting collaboration function is used, are performed for each point data item. In such a structure, the situation where strokes are written can be reproduced in more detail.

Hereinafter, the operations of apparatuses including the electronic apparatus 10 according to the present embodiment will be described. Here, the processes executed when the electronic apparatus 10 operates as an extragroup apparatus, that is, a distribution process and a collection process of shared information, will be mainly described. In the following description, it is assumed that the users A to C using the above-described respective apparatuses 10A to 10C constitute one group, the apparatus 10A is an owner apparatus (server apparatus), and the apparatuses 10B and 10C are participant apparatuses.

The electronic apparatus 10 operating as an extragroup apparatus will be referred to as an extragroup apparatus 10 for convenience. The apparatus 10A will be referred to as the owner apparatus 10A, and the apparatuses 10B and 10C will be referred to as the participant apparatuses 10B and 10C. A user using the extragroup apparatus 10 will be referred to as a user D. Further, in the following description, when we do not distinguish the owner apparatus and the participant apparatuses, the owner apparatus and the participant apparatuses may be simply referred to as intragroup apparatuses, respectively.

It is assumed that in the extragroup apparatus 10, the owner apparatus 10A, and the participant apparatuses 10B and 10C, the above-described handwriting application program 202 can be executed. That is, it is assumed that the extragroup apparatus 10, the owner apparatus 10A, and the participant apparatuses 10B and 10C each have the structure described with reference to FIG. 8 and FIG. 9.

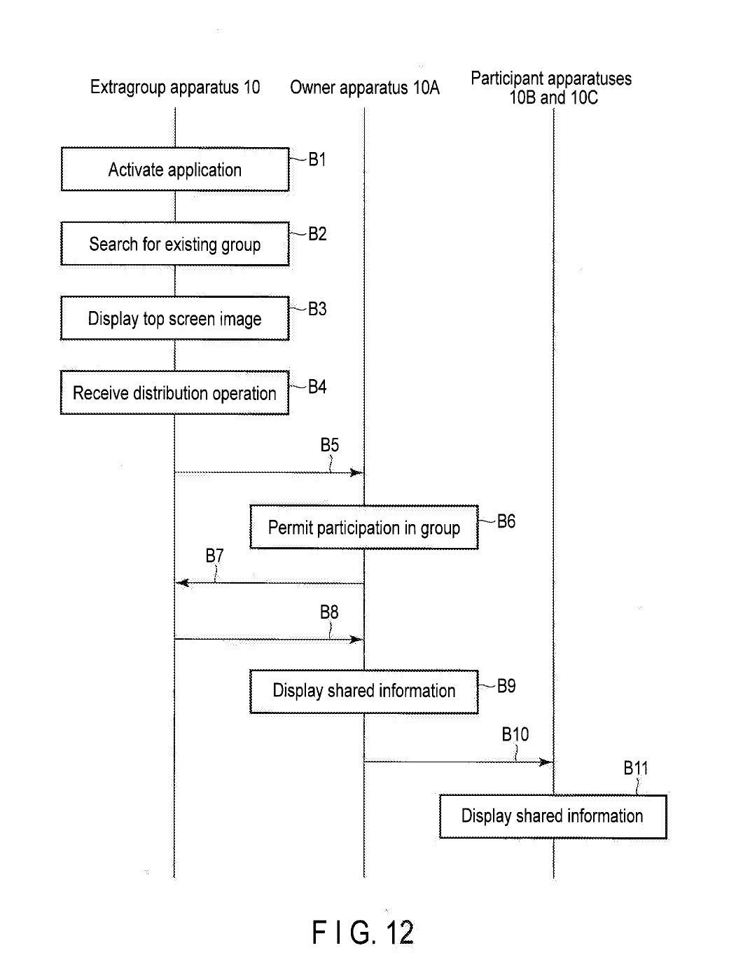

First, a procedure of the distribution process of shared information will be described with reference to the sequence chart of FIG. 12. The distribution process of shared information is a process which is executed to distribute shared information to users (here, the users A to C) constituting a pre-existing group (hereinafter, referred to as an existing group).

When distributing shared information to the users A to C constituting an existing group, the user D using the extragroup apparatus 10 activates a handwriting application program (handwriting collaboration function) in the extragroup apparatus 10 (block B1).

When the process of block B1 is executed, the extragroup apparatus 10 (distribution/collection processor 303d) searches for an existing group (block B2).

The process of block B2 will be explained specifically. If the intragroup apparatuses in the handwriting collaboration function are connected by Wi-Fi via an access point such as a router, the extragroup apparatus 10 multicasts a search request for searching for a group to apparatuses including the owner apparatus 10A and the participant apparatuses 10B and 10C existing on a wireless communication network (segment) by the Wi-Fi. The search request multicasted in this manner is received by the apparatuses including the owner apparatus 10A and the participant apparatuses 10B and 10C.

The owner apparatus 10A which received the search request returns a response to the search request to the extragroup apparatus 10 (that is, the apparatus which made the search request). The extragroup apparatus 10 can thereby recognize the existence of a group whose owner is the user A using the owner apparatus 10A. The response to the search request returned from the owner apparatus 10A includes, for example, a user name (user ID) of the user A using the owner apparatus 10A.

In addition, if there is an existing group other than the group constituted of the users A to C, the extragroup apparatus 10 receives a response to the search request from an apparatus used by a user who is an owner of the existing group (that is, an owner apparatus). The extragroup apparatus 10 can thereby recognize (search for) all the existing groups in the wireless communication network.

Although the search request is also received by the participant apparatuses 10B and 10C as described above, the participant apparatuses 10B and 10C do not return any response to the search request. The same holds true of an apparatus used by a user not constituting an existing group (that is, an extragroup apparatus).

Although the case where intragroup apparatuses are connected by Wi-Fi has been herein explained, the same holds true of the case where Wi-Fi Direct or Bluetooth is used. That is, in this case, it suffices if a search request is transmitted to apparatuses with which the extragroup apparatus 10 can directly communicate by Wi-Fi Direct or Bluetooth.

When the process of block B2 is executed, the extragroup apparatus 10 (display processor 302) displays a top screen image in the handwriting collaboration function on a display (LCD 12A) of the extragroup apparatus 10 (block B3).

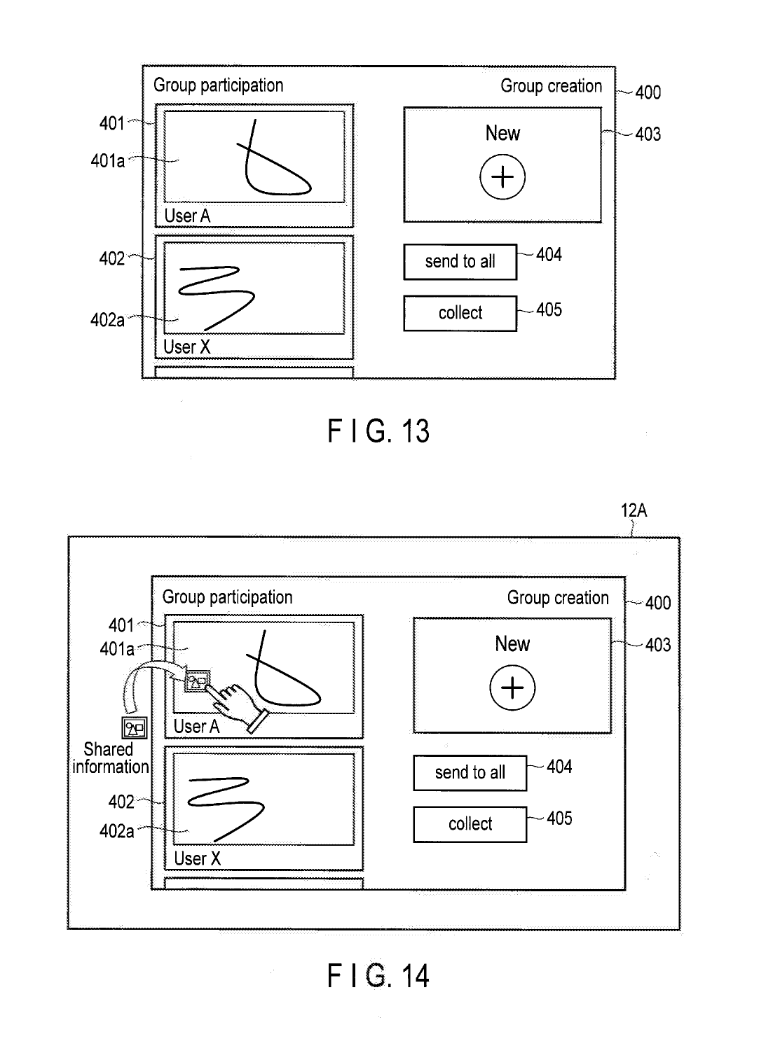

Here, FIG. 13 shows the top screen image in the handwriting collaboration function.

For example, in a left area of the top screen image 400 shown in FIG. 13, existing group icons 401 and 402 representing existing groups searched for by the extragroup apparatus 10 are displayed in a list.

The existing group icon 401 includes the user name of the user A, and represents a group whose owner is the user A. The existing group icon 401 includes a thumbnail image 401a representing shared information shared among the group whose owner is the user A (that is, the shared screen images displayed in the owner apparatus 10A and the participant apparatuses 10B and 10C). The user name of the user A included in the existing group icon 401 can be acquired and displayed from the above-described response to the search request returned from the owner apparatus 10A used by the user A.

The existing group icon 402 includes a user name of a user X, and represents a group whose owner is the user X. The existing group icon 402 includes a thumbnail image 402a representing shared information shared among the group whose owner is the user X. The user name of the user X included in the existing group icon 402 can be acquired and displayed from a response to a search request returned from an owner apparatus used by the user X.

On the top screen image 400 shown in FIG. 13, only the existing group icons 401 and 402 representing the two groups are displayed. However, if three or more existing groups are searched for in the above-described process of block B2, all the existing group icons may be displayed on the top screen image 400 by adjusting the size of the existing group icons. In addition, icons other than the existing group icons 401 and 402 may be displayed by, for example, scrolling the top screen image 400.

The existing group icons 401 and 402 displayed on the top screen image 400 are used when the user D using the extragroup apparatus 10 participates in an existing group.

Specifically, the user D using the extragroup apparatus 10 performs an operation of designating, for example, the existing group icon 401 on the top screen image 400 displayed in the extragroup apparatus 10 (for example, an operation of touching the existing group icon 401). In this case, the extragroup apparatus 10 (group participation processor 303b) transmits a group participation request to the owner apparatus 10A used by the owner (here, the user A) of the group represented by the designated existing group icon 401.

The owner apparatus 10A (group creation processor 303a) receives the group participation request transmitted by the extragroup apparatus 10, and displays a screen image for inquiring of the user A whether to permit the user D using the extragroup apparatus 10 to participate in the group (hereinafter, referred to as an inquiry screen image) on the display of the owner apparatus 10A in response to the group participation request. The inquiry screen image is provided with, for example, a permission button and a denial button. The user A can thereby instruct the owner apparatus 10A on whether to permit or deny the participation of the user D in the group.

When being instructed by the user A to permit the participation of the user D in the group, the owner apparatus 10A notifies the extragroup apparatus 10 that the participation in the group has been permitted. In this case, the extragroup apparatus 10 operates as a participant apparatus in the group.

By using the existing group icons 401 and 402 displayed on the top screen image 400 as described above, the user D using the extragroup apparatus 10 can participate in a desired group.

When being instructed by the user A to deny the participation of the user D in the group, the owner apparatus 10A notifies the extragroup apparatus 10 that the participation in the group has been denied. Specifically, a screen image for notifying the user D that the participation in the group has been denied is displayed on the display of the extragroup apparatus 10. In this case, the user D cannot participate in, for example, the group represented by the existing group icon 401.

Further, for example, in an upper right area of the top screen image 400, a new group icon 403 is displayed. The new group icon 403 is used when the user D using the extragroup apparatus 10 newly creates a group.

Specifically, the user D using the extragroup apparatus 10 performs an operation of designating, for example, the new group icon 403 on the top screen image 400 displayed in the extragroup apparatus 10 (for example, an operation of touching the new group icon 403). In this case, the user D can newly create a group whose owner is the user D through a group creation screen image displayed on the display of the extragroup apparatus 10. On the group creation screen image, a name of a group, a user name of the user D to be an owner, and a connection mode with participant apparatuses (for example, Wi-Fi, Wi-Fi Direct, Bluetooth, etc.) are designated.

By using the new group icon 403 displayed on the top screen image 400 as described above, the user D using the extragroup apparatus 10 can create a new group. When the user D creates a new group, the extragroup apparatus 10 operates as an owner apparatus (server apparatus) in the group.

Moreover, a “send to all” button 404 and a “collect” button 405 are disposed, for example, in a lower right area of the top screen image 400. The user D using the extragroup apparatus 10 can perform an operation of designating these buttons 404 and 405 on the top screen image 400, and the operations performed when the buttons 404 and 405 are designated will be described later.

Here, the existing group icons 401 and 402 displayed on the top screen image 400 are used not only when the user D participates in an existing group, but also when the user D distributes shared information to (users constituting) an existing group.

The top screen image 400 can also be displayed on the whole screen of the display (LCD 12A) of the extragroup apparatus 10, and can be displayed on, for example, part of the display like a window as shown in FIG. 14. In this case, the user D can perform an operation of dragging and dropping (a file of) shared information disposed in an area (for example, a home screen image) other than the top screen image (window) 400 as shown in FIG. 14 to an existing group icon (here, the existing group icon 401) representing an existing group to which the shared information is distributed, as an operation for distributing the shared information to the existing group (hereinafter, referred to as a distribution operation). A screen image displaying a list of information sharable among an existing group may be displayed near the top screen image. In this case, it suffices if an operation of dragging and dropping desired shared information from such a screen image to an existing group icon is performed. By such a distribution operation, the user D can select (designate) shared information and an existing group (destination) to which the shared information is distributed.

Returning to FIG. 12 again, when the user D performs a distribution operation, the extragroup apparatus 10 (distribution/collection processor 303d) receives the distribution operation (block B4). It is herein assumed that a distribution operation of dragging and dropping a file of shared information to the existing group icon 401 as shown in FIG. 14 has been received. In the following description, the existing group represented by the existing group icon 401, that is, the existing group constituted of the users A to C, will be referred to as a distribution target group.

In this case, the extragroup apparatus 10 transmits a group participation request to the owner apparatus 10A used by the user A, who is an owner of the distribution target group (block B5).

The owner apparatus 10A receives the group participation request transmitted by the extragroup apparatus 10, and displays the above-described inquiry screen image on the display of the owner apparatus 10A. It is herein assumed that the user A using the owner apparatus 10A has instructed the owner apparatus 10A to permit the participation of the user D using the extragroup apparatus 10 in the distribution target group (block B6).

In this case, the owner apparatus 10A notifies the extragroup apparatus 10 that the participation in the distribution target group has been permitted (block B7).

The participation of the user D in the distribution target group may be permitted unconditionally. In this case, the inquiry screen image is not displayed on the display of the owner apparatus 10A, and the process of block B6 is omitted. Whether or not the permission of the user A using the owner apparatus 10A is necessary for the participation of another user (for example, the user D) in the distribution target group can be set on the owner apparatus 10A side.

When the process of block B7 is executed, the extragroup apparatus 10 (distribution/collection processor 303d) transmits the file of the shared information dragged and dropped to the existing group icon 401 to the owner apparatus 10A, and notifies the owner apparatus 10A that the extragroup apparatus 10 will separate from the distribution target group (block B8). Accordingly, the extragroup apparatus 10 will not be handled as a participant apparatus in the distribution target group in the subsequent processes for the distribution target group.

The owner apparatus 10A receives the file of the shared information transmitted by the extragroup apparatus 10, and displays the shared information on the display of the owner apparatus 10A (block B9).

In addition, the owner apparatus 10A transmits the file of the shared information transmitted by the extragroup apparatus 10 to the participant apparatuses 10B and 10C to share the shared information among the distribution target group (block B10).

The participant apparatuses 10B and 10C receive the file of the shared information transmitted by the owner apparatus 10A, and display the shared information on displays, respectively (block B11).

According to the processes shown in FIG. 12, the participation in an existing group (distribution target group), the distribution (transmission) of shared information, and the separation from the existing group can be carried out by performing the above-described distribution operation. Thus, even a user not participating in an existing group can distribute shared information to users in the existing group by a simple operation.

It has been herein explained that shared information is distributed to one group. However, for example, when the “send to all” button 404 is designated by the user D using the extragroup apparatus 10 on the above-described top screen image 400 shown in FIG. 13, the above-described participation in an existing group, distribution of shared information, and separation from the existing group are repeatedly carried out for each existing group. Accordingly, shared information can be collectively distributed to existing groups. Shared information to be collectively distributed may be selected, for example, on a screen image showing a list of sharable information which is displayed after the “send to all” button 404 is designated, or may be designated by an operation of dragging and dropping the shared information to the “send to all” button 404.

When shared information is distributed from the user D to the users A to C constituting the existing group in this manner, the users A to C can input stroke data (handwritten character string, handwritten figure, etc.) in handwriting on the shared screen images of their own apparatuses (intragroup apparatuses) 10A to 10C in which the shared information is displayed. Stroke data input in handwriting in the respective intragroup apparatuses 10A to 10C is displayed on the shared screen images of all the intragroup apparatuses 10A to 10C. That is, screen display and handwriting operation are synchronized between the intragroup apparatuses 10A to 10C.

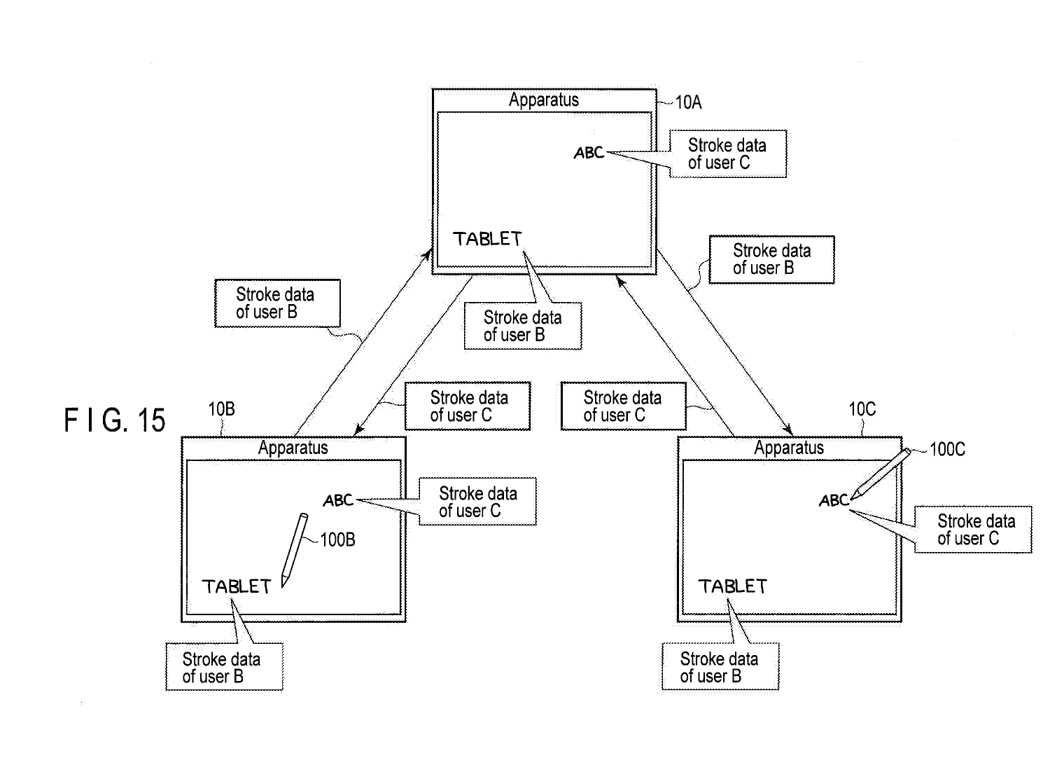

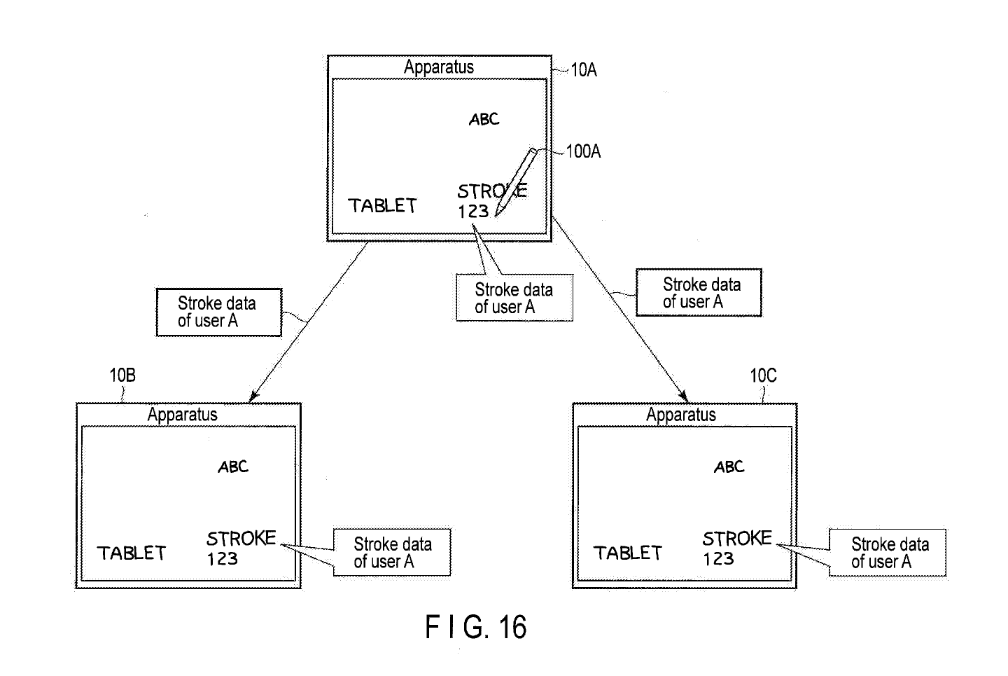

Here, the transition of the shared screen images displayed in the intragroup apparatuses 10A to 10C will be specifically described with reference to FIG. 15 and FIG. 16.

As shown in FIG. 15, when stroke data (for example, a handwritten character string “TABLET”) is input in handwriting with a pen 100B in the intragroup apparatus (participant apparatus) 10B, the stroke data of the user B is transmitted from the intragroup apparatus 10B to the intragroup apparatus (owner apparatus) 10A. The intragroup apparatus 10A displays the stroke data transmitted by the intragroup apparatus 10B on the shared screen image of the intragroup apparatus 10A, and transmits it to the intragroup apparatus 10C. The intragroup apparatus 10C displays the stroke data transmitted by the intragroup apparatus 10A on the shared screen image of the intragroup apparatus 10C. In this manner, for example, the handwritten character string “TABLET” (stroke data) input in handwriting in the intragroup apparatus 10B is displayed on the respective shared screens of the intragroup apparatuses 10A to 10C as shown in FIG. 15.

On the other hand, when stroke data (for example, a handwritten character string “ABC”) is input in handwriting with a pen 100C in the intragroup apparatus (participant apparatus) 10C as shown in FIG. 15, the stroke data of the user C is transmitted from the intragroup apparatus 10C to the intragroup apparatus 10A. The intragroup apparatus 10A displays the stroke data transmitted by the intragroup apparatus 10C on the shared screen image of the intragroup apparatus 10A, and transmits it to the intragroup apparatus 10B. The intragroup apparatus 10B displays the stroke data transmitted by the intragroup apparatus 10A on the shared screen image of the intragroup apparatus 10B. In this manner, for example, the handwritten character string “ABC” (stroke data) input in handwriting in the intragroup apparatus 10C is displayed on the respective shared screen images of the intragroup apparatuses 10A to 10C as shown in FIG. 15.

In addition, when stroke data (for example, a handwritten character string “STROKE 123”) is input in handwriting with a pen 100A in the intragroup apparatus 10A as shown in FIG. 16, the stroke data of the user A is transmitted from the intragroup apparatus 10A to the intragroup apparatuses 10B and 10C. The intragroup apparatus 10B displays the stroke data transmitted by the intragroup apparatus 10A on the shared screen image of the intragroup apparatus 10B. Similarly, the intragroup apparatus 10C displays the stroke data transmitted by the intragroup apparatus 10A on the shared screen image of the intragroup apparatus 10C. In this manner, for example, the handwritten character string “STROKE 123” (stroke data) input in handwriting in the intragroup apparatus 10A is displayed on the respective shared screen images of the intragroup apparatuses 10A to 10C as shown in FIG. 16.

Although wireless communication is performed only between the intragroup apparatus 10A and the intragroup apparatus 10B and between the intragroup apparatus 10A and the intragroup apparatus 10C in FIG. 15 and FIG. 16, the intragroup apparatuses 10B and 10C, which are participant apparatuses, can be allowed to directly communicate with each other, for example.

In addition, stroke data can also be transmitted to all the apparatuses connected to a network (segment) through, for example, broadcasting, instead of being transmitted individually to each of the intragroup apparatuses. In this case, key information for use (that is, display, etc.) of stroke data is managed in the intragroup apparatuses. Accordingly, stroke data can be used in the intragroup apparatuses only, even if the stroke data is transmitted through broadcasting.

Moreover, although it has been herein explained that stroke data is directly transmitted and received between the intragroup apparatus (owner apparatus) 10A and the intragroup apparatuses (participant apparatuses) 10B and 10C, stroke data may be transmitted and received between the intragroup apparatus 10A and the intragroup apparatuses 10B and 10C through, for example, an external server device.

Here, when stroke data is input in handwriting on the shared screen images of the owner apparatus 10A and the participant apparatuses 10B and 10C, which are intragroup apparatuses, after shared information is distributed to the group constituted of the users A to C through the above-described processes shown in FIG. 12, (the user D using) the extragroup apparatus 10 can collect shared information after the stroke data is input in handwriting from the group. Although it is herein explained, for convenience, that shared information is collected after the shared information is distributed, distribution and collection of shared information are independent of each other. That is, shared information need not be collected after the shared information is distributed, and shared information other than shared information distributed through the processes shown in FIG. 12 may be collected, for example.

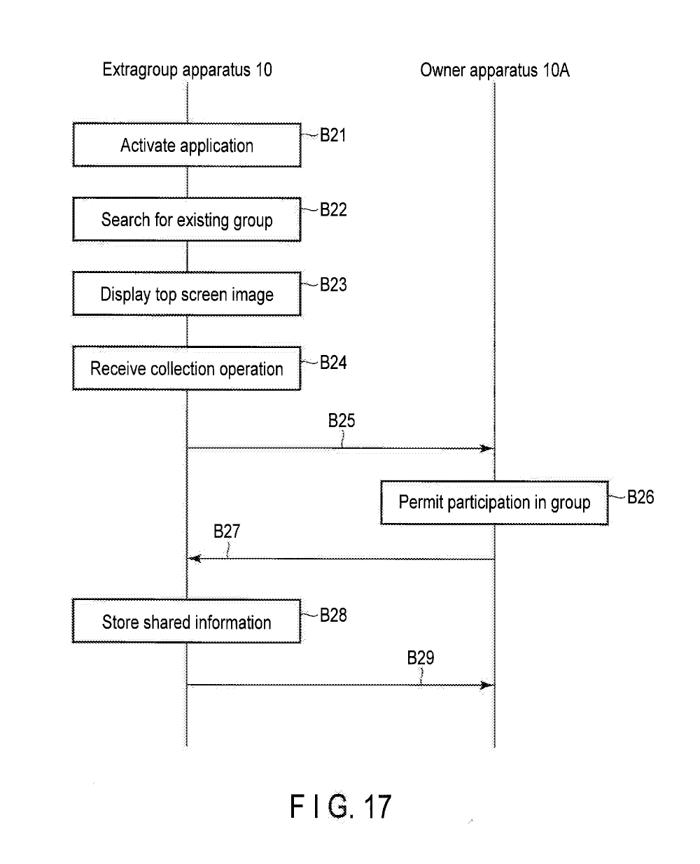

Hereinafter, a procedure of the collection process of shared information will be described with reference to the sequence chart of FIG. 17. The collection process of shared information is a process executed to collect shared information shared among an existing group (shared information edited in the existing group).

When shared information shared among the existing group is collected, blocks B21 to B23 corresponding to the above-described processes of blocks B1 to B3 shown in FIG. 12 are executed in the extragroup apparatus 10. In this case, the above-described top screen image 400 shown in FIG. 13 is displayed in the extragroup apparatus 10.

Here, the user D using the extragroup apparatus 10 can perform an operation for collecting shared information shared among an existing group (hereinafter, referred to as a collection operation). The collection operation includes, for example, an operation of touching the “collect” button 405 on the top screen image 400.

When the user D performs a collection operation, the extragroup apparatus 10 (distribution/collection processor 303d) receives the collection operation (block B24).

When the process of block B24 is executed, the following processes in and after block B25 are executed for each of the existing groups (that is, existing groups searched for in block B2) represented by the existing group icons displayed on the top screen image 400. Hereinafter, an existing group for which the processes in and after block B25 are performed will be referred to as a collection target group. The owner apparatus 10A in the following description is an owner apparatus in the collection target group.

In this case, the processes of blocks B25 and B26 corresponding to the above-described processes of blocks B5 and B6 shown in FIG. 12 are executed. When it is set on the owner apparatus 10A side that the permission of the user A is unnecessary for the participation of another user (here, the user D) in the collection target group (that is, the participation is unconditionally permitted), the process of block B26 is omitted.

Next, the owner apparatus 10A notifies the extragroup apparatus 10 that the participation in the collection target group has been permitted, and transmits (a file of) shared information shared among the collection target group (managed by the owner apparatus 10A) to the extragroup apparatus 10 (block B27). The shared information transmitted in block B27 is, for example, information indicating a result of inputting stroke data in handwriting by the users A to C on the shared screen images on which shared information distributed to the group constituted of the owner apparatus 10A and the participant apparatuses 10B and 10C in the above-described processes shown in FIG. 12 is displayed. The shared information transmitted in block B27 may be other information as long as it is shared among the collection target group.

The extragroup apparatus 10 receives the file of the shared information transmitted by the owner apparatus 10A, and stores the shared information in the extragroup apparatus 10 (block B28). The shared information stored in the extragroup apparatus 10 may be displayed on the display of the extragroup apparatus 10, or may be held in, for example, an external server device.

When the process of block B28 is executed, the extragroup apparatus 10 notifies the owner apparatus 10A that it will separate from the collection target group (block B29). Accordingly, the extragroup apparatus 10 will not be handled as a participant apparatus in the collection target group in the subsequent processes for the collection target group.

As described above, the processes of blocks B25 to B29 are executed, for example, for each existing group. According to the processes shown in FIG. 17, the participation in an existing group (collection target group), the collection (reception) of shared information, and the separation from the existing group are successively carried out for each existing group by performing the above-described collection operation. Thus, even a user not participating in an existing group can collect shared information from the existing group by a simple operation.

Although it has been herein explained that shared information is collected from all the existing groups, (an existing group icon representing) one existing group may be designated as a source so that shared information is collected from the designated existing group, for example. Specifically, the collection of shared information from an existing group represented by an existing group icon may be instructed by performing an operation of touching the existing group icon for a predetermined period, for example.

Hereinafter, how the electronic apparatus 10 according to the present embodiment is used will be specifically described. The electronic apparatus 10 according to the present embodiment can be used in, for example, an educational scene such as a school. In this case, the extragroup apparatus 10 is used by a teacher. The respective intragroup apparatuses 10A to 10C (owner apparatus 10A and participant apparatuses 10B and 10C) are used by students A to C constituting one group. It is assumed that the students A to C constituting the same group use the apparatuses 10A to 10C, for example, when doing group study, assembling at the same classroom. In the case where the extragroup apparatus 10 is used by the teacher (manager), the extragroup apparatus 10 may have a function for displaying handwriting (stroke data) made on the intragroup apparatuses 10A to 10C if an icon indicative of the group is selected by the teacher.

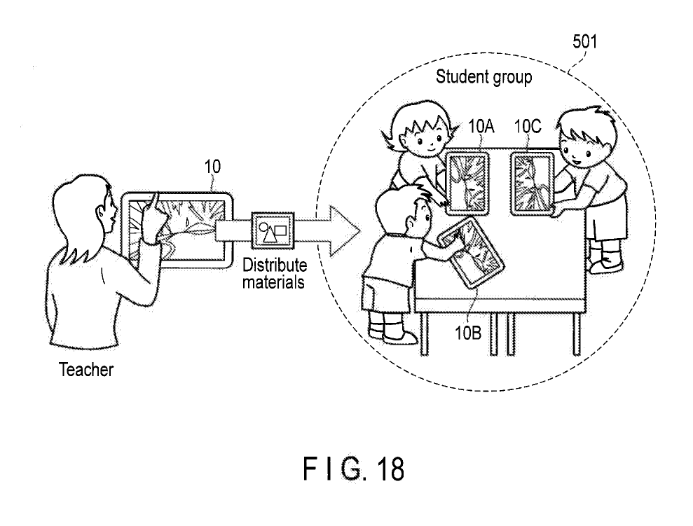

In this case, as shown in FIG. 18, the teacher can distribute, for example, materials (text data, image data, etc.) including a problem used in class to a student group 501 as shared information, by performing a distribution operation for the extragroup apparatus 10.

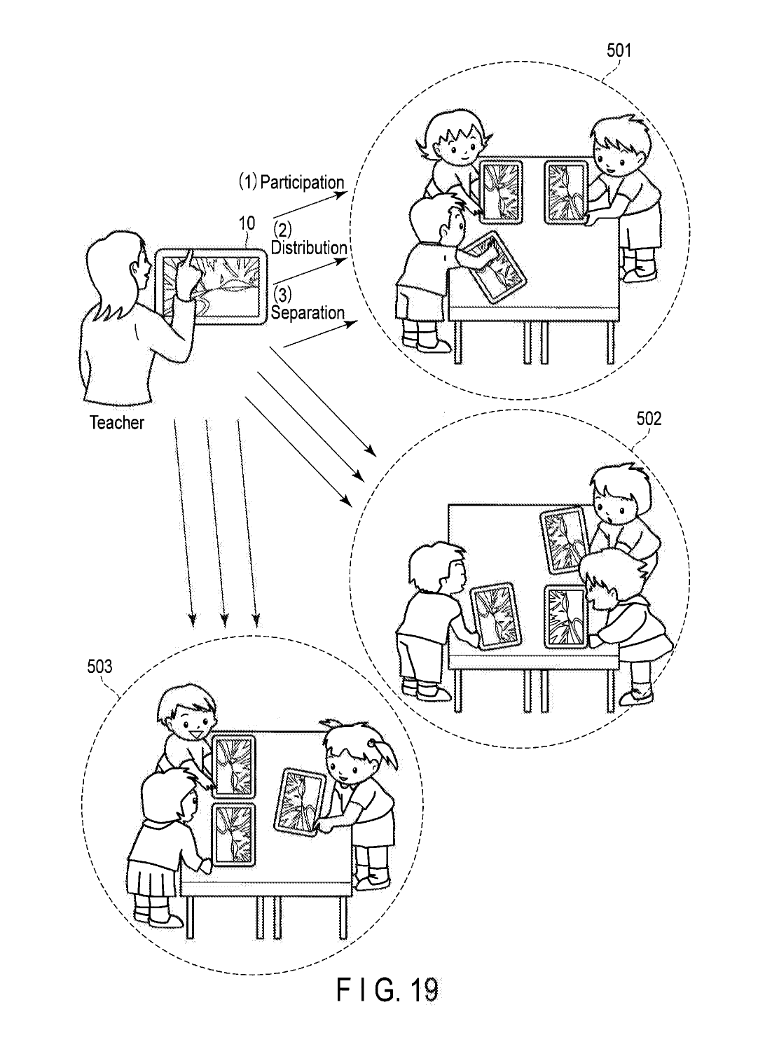

In addition, when there are student groups 501 to 503 as shown in FIG. 19, the teacher can also distribute materials to the student groups 501 to 503 collectively by designating the “send to all” button 404 on the above-described top screen image 400. This collective distribution of materials is achieved by successively carrying out the above-described participation in a student group, distribution (transmission) of materials, and separation from the student group for each student group.

When materials are distributed to, for example, the student group 501 in this manner, the materials are displayed on the shared screen images of the intragroup apparatuses 10A to 10C. In this case, the students A to C constituting the student group 501 can input stroke data in handwriting on the shared screen images of the intragroup apparatuses 10A to 10C. The shared screen images reflect not only one's own stroke data input in handwriting but also stroke data input in handwriting by other students. Accordingly, the students A to C can prepare an answer to a problem by collaborative work by performing handwriting input on the shared screen images of the intragroup apparatuses 10A to 10C. The same holds true of the students groups 502 and 503.

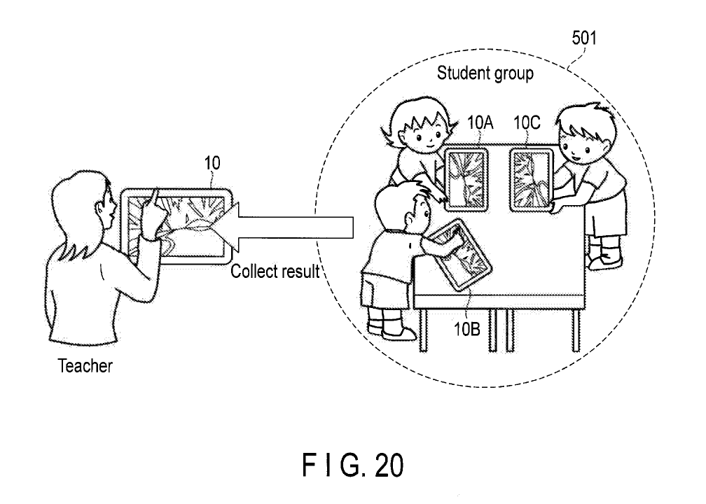

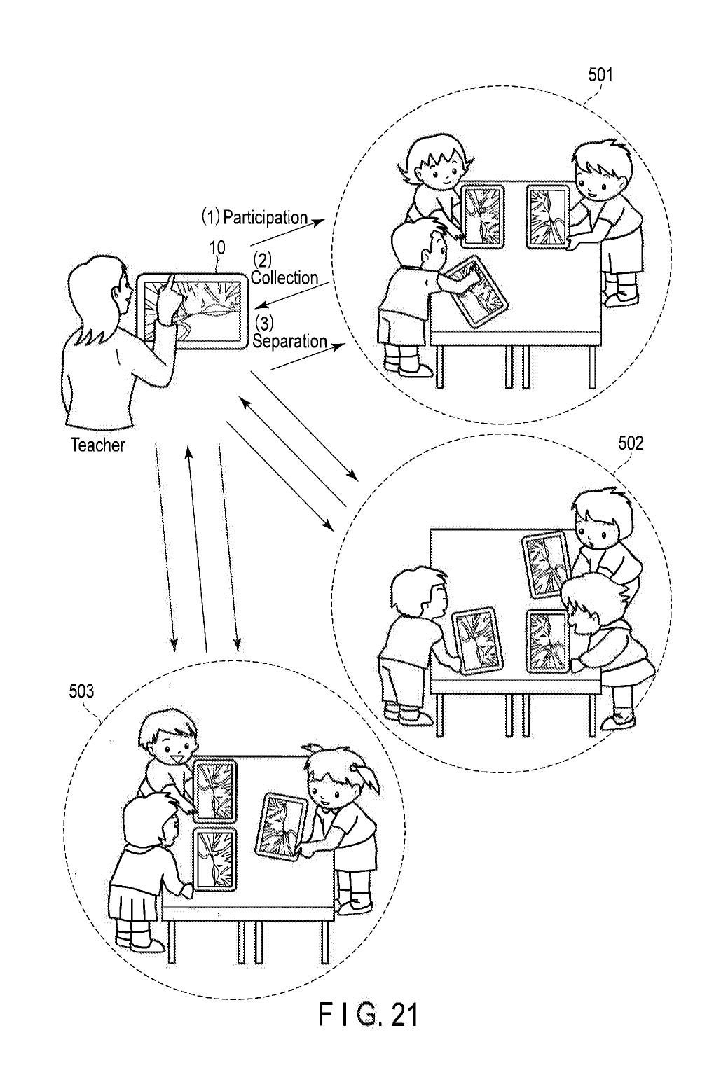

When the answer to the problem is prepared, the teacher can collect the answer (result) to the problem from, for example, the student group 501 by performing a collection operation for the extragroup apparatus 10 as shown in FIG. 20. When the student groups 501 to 503 exist as shown in FIG. 21, answers can also be collectively collected from the student groups 501 to 503 by carrying out the participation in a student group, the collection (reception) of an answer, and the separation from the student group successively for each student group.

The electronic apparatus 10 according to the present embodiment is useful in, for example, making students do group study as described with reference to FIG. 18 to FIG. 21, but may also be used for other purposes such as meetings in companies.

As described above, in the present embodiment, a group including users (first users) using respective intragroup apparatuses by which information is sharable is searched for, and shared information (first shared information) to be shared among the group searched for is transmitted to at least one of the intragroup apparatuses used by the users constituting in the group. In the present embodiment, according to such a structure, even a user (second user) other than the users constituting the group can easily distribute information to be shared among the group to (the users constituting) the group. Shared information is transmitted to an owner apparatus in the group and is transmitted from the owner apparatus to participant apparatuses, thereby being shared among the group.

In the present embodiment, when groups are searched for, shared information is distributed to a group selected by a user using an extragroup apparatus 10. Accordingly, shared information can be distributed to a desired group. Shared information can also be distributed to each of the groups collectively. In this case, because it is unnecessary to perform an operation for distributing shared information for each group, the user's problem can be alleviated.

In addition, in the present embodiment, a search request is transmitted to apparatuses existing on a network to which an extragroup apparatus 10 is connected, and a response to the search request is received from an owner apparatus of each group, whereby existing groups can be searched for.

Moreover, in the present embodiment, shared information (second shared information) shared among a group searched for is received from at least one of intragroup apparatuses used by users in the group. In the present embodiment, according to such a structure, even a user other than the users constituting the group can easily collect information shared among the group (shared information) from the group. Shared information is received from, for example, an owner apparatus in the group.

In the present embodiment, when groups are searched for, shared information is collected from a group selected by a user using an extragroup apparatus 10. Accordingly, shared information can be collected from a desired group. Shared information can also be collected from each of the groups collectively. In this case, because it is unnecessary to perform an operation for collecting shared information for each group, the user's problem can be alleviated.

In addition, in the present embodiment, shared information including stroke data input in handwriting in respective intragroup apparatuses is collected. Accordingly, for example, when students do group study, an answer (result of the group study), etc., which the respective students prepared by handwriting input can be collected.

Various functions disclosed in the present embodiment may also be each implemented by at least one processing circuit. The processing circuit includes a programmed processor such as a central processing unit (CPU). The processor executes each of the above-described functions by executing a program stored in a memory. The processor may be a microprocessor including an electronic circuit. Examples of the processing circuit also include a digital signal processor (DSP), an application-specific integrated circuit (ASIC), a microcontroller, a controller, and other electronic circuit components.

In addition, because various processes of the present embodiment can be implemented by a computer program, the same advantages as those of the present embodiment can be easily achieved only by installing the computer program in a normal computer through a computer-readable storage medium storing the computer program and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a transceiver configured to receive handwriting made on other electronic apparatuses;
a screen capable of displaying the handwriting;
a hardware processor configured to:
display a first icon indicative of a first group comprising a first electronic apparatus and a second electronic apparatus and a second icon indicative of a second group comprising a third electronic apparatus and a fourth electronic apparatus;
display handwriting made on the first electronic apparatus and the second electronic apparatus, if the first icon is selected by a user;
display handwriting made on the third electronic apparatus and the fourth electronic apparatus, if the second icon is selected by the user;
receive a selection of a first file;
transmit the first file to the first electronic apparatus and the second electronic apparatus, if the first group is selected as a destination of the first file through the first icon;
transmit the first file to the third electronic apparatus and the fourth electronic apparatus, if the second group is selected as the destination of the first file through the second icon.

2. The electronic apparatus of claim 1, wherein
the hardware processor is configured to:
transmit the first file to the first electronic apparatus, if the first group is selected, and
transmit the first file to the third electronic apparatus, if the second group is selected,
the first file is transmitted from the first electronic apparatus to the second electronic apparatus, if the first file is transmitted to the first electronic apparatus, and
the first file is transmitted from the third electronic apparatus to the fourth electronic apparatus, if the first file is transmitted to the third electronic apparatus.

3. The electronic apparatus of claim 2, wherein the hardware processor is configured to transmit the first file to the first to fourth electronic apparatus, if all groups are selected as the destination.

4. The electronic apparatus of claim 2, wherein the hardware processor is configured to:
transmit a search request for searching for a group via a network in communication with the electronic apparatus and the first and third electronic apparatus, and
search for the first group and the second group by receive a response to the search request from the first electronic apparatus and the third electronic apparatus.

5. The electronic apparatus of claim 1, wherein the hardware processor is configured to:
receive a second file shared among the first group from the first electronic apparatus, if the first group is selected as a source through the first icon, and
receive a third file shared among the second group from the third electronic apparatus, if the second group is selected as the source through the second icon.

6. The electronic apparatus of claim 5, wherein the hardware processor is configured to receive the second file from the first electronic apparatus and the third file from the third electronic apparatus, if all groups are selected as the source.

7. The electronic apparatus of claim 1, wherein the hardware processor comprises:
means for displaying a first icon indicative of a first group comprising a first electronic apparatus and a second electronic apparatus and a second icon indicative of a second group comprising a third electronic apparatus and a fourth electronic apparatus;
means for displaying handwriting made on the first electronic apparatus and the second electronic apparatus, if the first icon is selected by a user;
means for displaying handwriting made on the third electronic apparatus and the fourth electronic apparatus, if the second icon is selected by the user;
means for receiving a selection of a first file;
means for transmitting the first file to the first electronic apparatus and the second electronic apparatus, if the first group is selected as a destination of the first file through the first icon;
means for transmitting the first file to the third electronic apparatus and the fourth electronic apparatus, if the second group is selected as the destination of the first file through the second icon.

8. A method comprising:
displaying a first icon indicative of a first group comprising a first electronic apparatus and a second electronic apparatus and a second icon indicative of a second group comprising a third electronic apparatus and a fourth electronic apparatus on a screen;
displaying handwriting made on the first electronic apparatus and the second electronic apparatus on the screen, if the first icon is selected by a user;
displaying handwriting made on the third electronic apparatus and the fourth electronic apparatus on the screen, if the second icon is selected by the user;
receiving a selection of a first file;
transmitting the first file to the first electronic apparatus and the second electronic apparatus, if the first group is selected as a destination of the first file through the first icon;
transmitting the first file to the third electronic apparatus and the fourth electronic apparatus, if the second group is selected as the destination of the first file through the second icon.

9. The method of claim 8, comprising
transmitting the first file to the first electronic apparatus if the first group is selected, and
transmitting the first file to the third electronic apparatus, if the second group is selected,
wherein
the first file is transmitted from the first electronic apparatus to the second electronic apparatus, if the first file is transmitted to the first electronic apparatus, and
the first file is transmitted from the third electronic apparatus to the fourth electronic apparatus, if the first file is transmitted to the third electronic apparatus.

10. The method of claim 9, comprising transmitting the first file to the first to fourth electronic apparatus, if all groups are selected as the destination.

11. The method of claim 9, comprising:
transmitting a search request for searching for a group via a network in communication with the electronic apparatus and the first and third electronic apparatus, and
searching for the first group and the second group by receiving a response to the search request from the first electronic apparatus and the third electronic apparatus.

12. The method of claim 8, comprising:
receiving a second file shared among the first group from the first electronic apparatus, if the first group is selected as a source through the first icon, and
receiving a third file shared among the second group from the third electronic apparatus, if the second group is selected as the source through the second icon.

13. The method of claim 12, comprising receiving the second file from the first electronic apparatus and the third file from the third electronic apparatus, if all groups are selected as the source.
